(19) United States
(12) Patent Application Publication
(10) Pub. No.: US 2016/0373380 A1
(43) Pub. Date: Dec. 22, 2016

(54) PACKET RECEPTION APPARATUS

(71) Applicant: NTT Electronics Corporation, Yokohama-shi, Kanagawa (JP)

(72) Inventors: Hidenori NAGAYAMA, Kanagawa (JP); Hiromi FUJITA, Kanagawa (JP); Hidetoshi SUZUKI, Kanagawa (JP)

(21) Appl. No.: 15/118,013

(22) PCT Filed: Nov. 25, 2014
(86) PCT No.: PCT/JP2014/081124

§ 371 Date: Aug. 10, 2016

(30) Foreign Application Priority Data
Mar. 10, 2014 (JP) 2014-046283

(51) Int. Cl. H04L 12/861; H04L 12/26; H04L 12/64

(52) U.S. Cl. CPC H04L 49/9005; H04L 12/6418; H04L 43/16

(57) ABSTRACT

A packet reception apparatus receives a plurality of types of packets classified in categories including at least one of a content of a request information from a transmission side, a type of packet communication format, and a video data compression method. A plurality of buffers (B-1, B-2) assort the plurality of types of received packets according to the types thereof and store the plurality of types of received packets as assorted. A packet extraction processing unit extracts the packets stored in the plurality of buffers (B-1, B-2) according to a packet processing condition table. A packet calculation processing unit performs a calculation process of the packets extracted by the packet extraction processing unit.

### FIELD

The present invention relates to a packet reception apparatus that receives a plurality of types of packets.

### BACKGROUND

As a packet reception apparatus that switches among a plurality of types of received packets, an apparatus is proposed that switches between receiving multicast distribution content and unicast distribution content provided by a transmission apparatus (see PTL 1, for example).

### CITATION LIST

### Patent Literature

PTL 1: International Publication WO 2007/102547

### SUMMARY

### Technical Problem

In PTL 1, when switching is performed, a control signal for switching is sent from the reception apparatus to the transmission apparatus first, and then the reception apparatus switches and receives the distribution content from the transmission apparatus. Therefore, it is impossible to switch the content at the convenience of the transmission side.

Here, a specific example of switching content “at the convenience of the transmission side” is described using a video transmission system for monitoring rivers. A group of rivers including a river a in prefecture A, a river b in prefecture B, and a river c in prefecture C, which join together downstream to form a river z in prefecture Z, and a video transmission system for monitoring rivers that monitors the states of these entire rivers, are assumed.

Since river z is formed by the joining of three rivers, the surveillance camera video of river z in prefecture Z is shown as a representative image in the monitors at the river surveillance locations in prefectures A, B, C, and Z while in a normal state, such that the water level is monitored for all of the plurality of rivers. In a case where a site patrol group performing river surveillance in prefecture A discovers an abnormal location in a levee of river a, it is desired that the monitor videos at the surveillance locations in the other prefectures remain unchanged while the video of this abnormal location is quickly communicated to only the monitor of the surveillance location in prefecture A using the same network. When this emergency video transmission has finished, it is desired that the monitor video of the surveillance location in prefecture A returns to the original video of river z. The same situations can occur in prefectures B and C as well.

When such emergency video transmission is made, conventionally, it is necessary for a network manager to reset the network parameters such that the video at each location is moved to the desired monitor. A similar process is necessary when returning to the original video.

PTL 1 assumes that switching occurs only between multicast communication and unicast communication, and does not envision a process of switching for universal packet types such as switching the type of packet communication format between IPv4 packets and IPv6 packets or the video data compression method between video compression packets using MPEG-2 and video compression packets using H.264, for example.

Usually, a packet extraction processing unit that extracts stored packets and a packet calculation processing unit that performs a calculation process on the extracted packets are connected downstream from the buffers that store the received packets. In order for these units to operate stably, a certain amount of newly received types of packets need to be accumulated in a buffer and the switching is then performed after ensuring that the extraction process and calculation process are operating stably. If such steps are not taken, unstable operation such as a buffer becoming empty during the extraction process can occur immediately after the switching.

However, since the buffer shown in FIG. 5 of PTL 1 has a single memory structure, it is difficult to switch the content immediately without reducing the stability of the video transmission.

The present invention aims to solve the problems described above, and to provide a packet reception apparatus that can flexibly and quickly switch between many types of packets and realize stable operation.

### Solution to Problem

A packet reception apparatus according to the present invention receiving a plurality of types of packets classified in categories including at least one of a content of a request information from a transmission side, a type of packet communication format, and a video data compression method, includes: a plurality of buffers separately storing the plurality of types of received packets according to the types; a packet extraction processing unit extracting the packets stored in the plurality of buffers according to a packet processing condition table; and a packet calculation processing unit performing a calculation process of the packets extracted by the packet extraction processing unit.

### Advantageous Effects of Invention

The present invention makes it possible to flexibly and quickly switch between many types of packets and realize stable operation.

### BRIEF DESCRIPTION OF THE DRAWINGS

FIG. 1 is a block diagram showing a video transmission system for monitoring rivers according to an embodiment of the present invention.

FIG. 2 is a block diagram showing a video transmission system for monitoring rivers according to an embodiment of the present invention.

FIG. 3 is a block diagram showing a packet reception apparatus according to an embodiment of the present invention.

### DESCRIPTION OF EMBODIMENTS

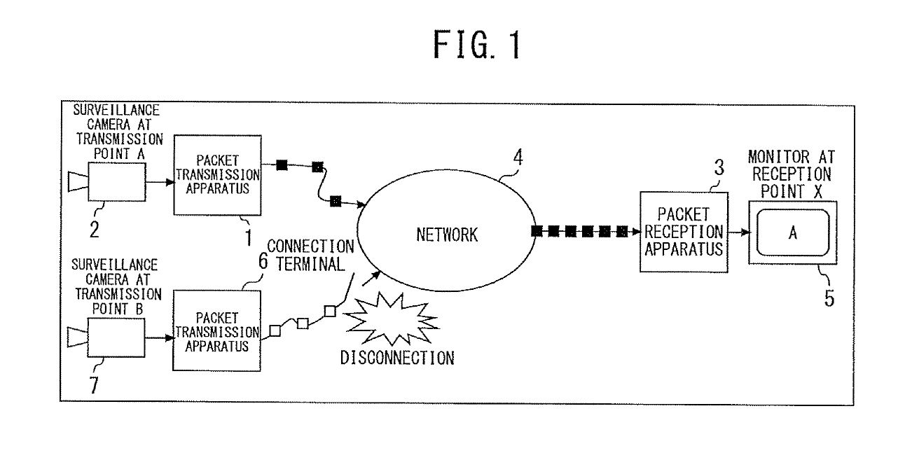

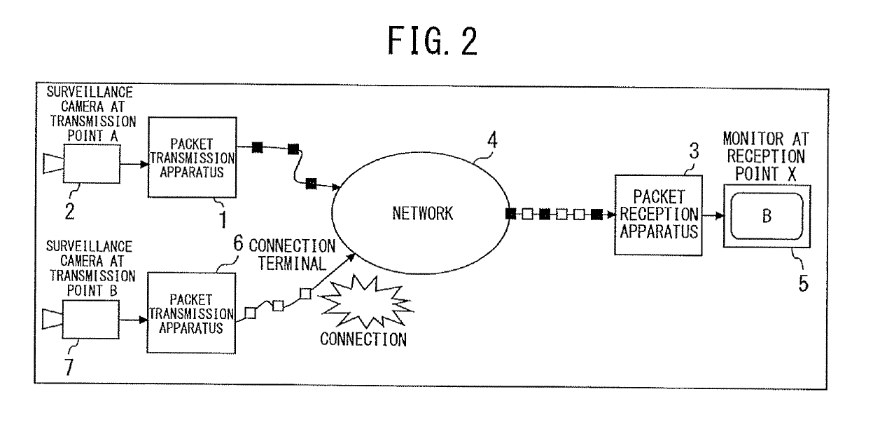

FIGS. 1 and 2 are block diagrams showing a video transmission system for monitoring rivers according to an embodiment of the present invention. In FIG. 1, a packet transmission apparatus 1 transmits video of a surveillance camera 2 at a transmission point A as request information from the transmission side, under multicast conditions. This information is received by a packet reception apparatus 3 via a network 4, and displayed on a monitor 5 at a reception point X.

In FIG. 2, while packets are being transmitted from the packet transmission apparatus 1, a packet transmission apparatus 6 further transmits video of a surveillance camera 7 at a transmission point B as request information from the transmission side, under unicast conditions. In this case, the packets from the packet transmission apparatus 1 and the packets from the packet transmission apparatus 6 are mixed together upon arriving at the packet reception apparatus 3. In response to this, the display on the monitor 5 at the reception point X automatically switches to the video of the surveillance camera 2 at the transmission point B, without any operation being performed at the reception point X.

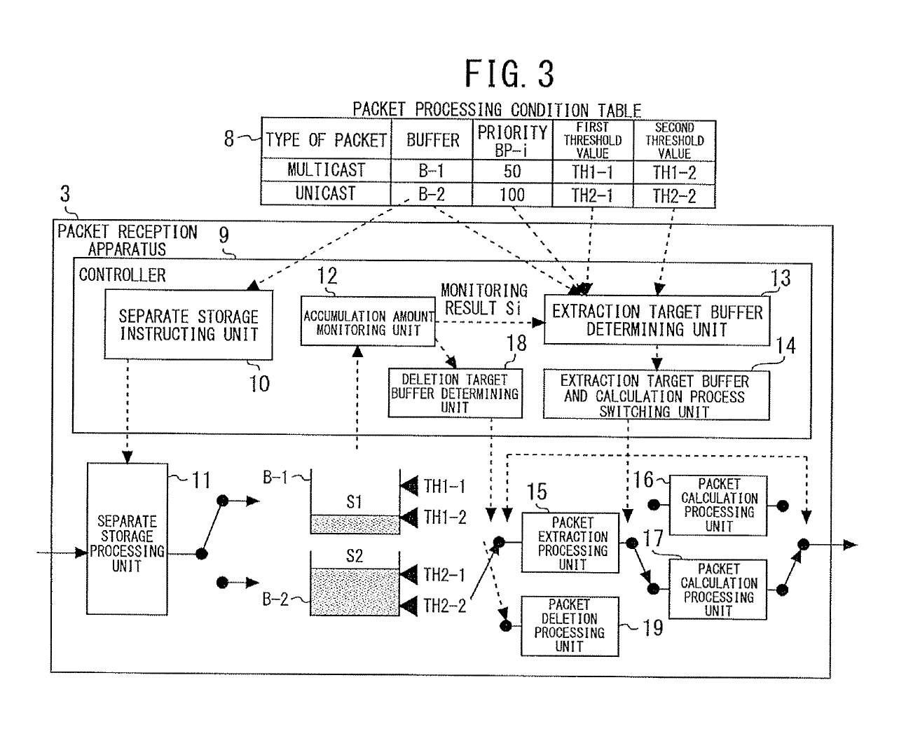

FIG. 3 is a block diagram showing a packet reception apparatus according to an embodiment of the present invention. The packet reception apparatus 3 receives two types of packets, i.e. multicast and unicast, which are the request information from the transmission side. The packet reception apparatus 3 operates based on a packet processing condition table 8. The packet processing condition table 8 sets the two types of packets, i.e. multicast and unicast, buffers B-1 and B-2 corresponding to the packet types, a processing priority BP-i for these buffers, first threshold values TH1-1 and TH2-1 for the packet accumulation amounts in the respective buffers, and second threshold values TH1-2 and TH2-2 that are smaller than the first threshold values for the packet accumulation amounts in the respective buffers. Here, the buffer priority BP-i is also a packet type priority corresponding to a 1:1 priority between the packet types.

First, a separate storage instructing unit 10 within a controller 9 sends instructions to a separate storage processing unit 11 based on the packet processing condition table 8. The separate storage processing unit 11 stores a received packet in the buffer B-1 if the packet is a multicast packet, and stores the received packet in the buffer B-2 if the packet is a unicast packet. In other words, the buffers B-1 and B-2 separately store the two types of received packets according to the types.

Next, an accumulation amount monitoring unit 12 monitors packet accumulation amounts S1 and S2 of the buffers B-1 and B-2. A extraction target buffer determination unit 13 determines a extraction target buffer, which is a buffer from which a packet is extracted , based on the monitoring result and the packet processing condition table 8. This determination obeys the following judgment function.

i=arg max BP-x

x∈{N∩{x;THx-1≦Sx}}

Here, i is the extraction target buffer number. BP-i is the priority of buffer i, and a greater value for BP-i indicates a higher priority. THi-1 is the first threshold value of the buffer i. Si is the packet accumulation amount monitoring result of the buffer i. N is the total number of buffers.

In other words, the extraction target buffer determination unit 13 sets the extraction target buffer to be the buffer having the highest priority among buffers whose accumulation amounts are greater than the first threshold values. In a case where the packet accumulation amount monitoring results are as shown in FIG. 3, the buffer B-2 is determined to be the extraction target buffer from the judgment function shown above.

A extraction target buffer and calculation process switching unit 14 switches the buffer from which packets are extracted by a packet extraction processing unit 15 and switches the packet calculation processing units 16 and 17 that perform calculation, based on the determination of the extraction target buffer determination unit 13. Accordingly, the packet extraction processing unit 15 extracts packets from the buffer having the highest priority among the buffers whose packet accumulation amounts are greater than the first threshold values. The packet calculation processing units 16 and 17 perform the calculation processes conforming to the packet types extracted by the packet extraction processing unit 15.

In a case where it is necessary to switch the extraction target buffer from the buffer B-2 to the buffer B-1 according to the determination result of the extraction target buffer determination unit 13, the switching is not performed immediately. The packet extraction from the buffer B-2 continues, and the accumulation amount S2 of the buffer B-2 is monitored by the accumulation amount monitoring unit 12. At the time when the packet accumulation amount S2 of the buffer B-2 from which packets are being extracted becomes less than the second threshold value TH2-2, the packet extraction processing unit 15 switches the buffer from which packets are extracted. At the same time that the extraction target buffer and calculation process switching unit 14 switches the extraction target buffer to the buffer B-1, the extraction target buffer and calculation process switching unit 14 also switches the packet calculation processing from the packet calculation processing unit 17 to the packet calculation processing unit 16, such that calculation conforming to the packet type can be performed. In this way, the process of extracting packets from the buffers is switched automatically on the reception side according to the transmitted packet type.

In a case where multicast and unicast packets arrive in a mixed manner, unicast packet processing having high priority is switched to. If no unicast packets are being received, multicast packet processing is returned to. When a deletion target buffer determination unit 18 has detected that a buffer that is not designated as the extraction target buffer has become full, a packet deletion processing unit 19 is instructed to perform a deletion process beginning with older packets. As described above, in the present embodiment, a plurality of buffers B-1 and B-2 are prepared and a plurality of types of received packets are stored separately in the respective buffers according to the type of packet. The packets stored in the plurality of buffers B-1 and B-2 are extracted according to the packet processing condition table 8. In this way, it is possible to flexibly switch between packets. For example, it is possible to change the packet reception method on the reception side simply for the convenience of the transmission side, e.g. by a request to start or stop the transmission of packets on the transmission side. Accordingly, there is no need for resetting of the network connection by a network manager and control from a reception-side system, and it is possible to change the packet reception method on the reception side according to an operation made by a supervisor on site.

Furthermore, it is possible to manage the buffers such that the buffers do not suddenly become empty or overflow around the time of the switching. Accordingly, it is possible to immediately switch between packets and then realize stable operation after the switching.

Furthermore, in the present embodiment, the packet extraction target is switched based on the request information from the transmission side that is multicast and unicast. The present invention is not limited to this, and it is possible to switch the packet extraction target based on the type of packet communication format such as IPv4 packets and IPv6 packets or on the video data compression method such as MPEG-2 and H.264. In such a case, it is necessary to change the operation of the separate storage processing unit 11 corresponding to the content of the packet processing condition table 8 and the packet type. In the present embodiment, there are two types of packets, but the same process can be performed for three or more types of packets. Accordingly, in the present embodiment, it is possible to handle a plurality of types of packets classified in categories including at least one of the content of the request information from the transmission side, the type of packet communication format, and the video data compression method, and therefore it is possible to handle many types of packets without being limited to a case where multicast communication and unicast communication are mixed together.

The above describes a plurality of physical buffers, but one physical buffer may be logically separated and each region resulting from the separation may be treated as a physically separated buffer. Furthermore, the packet processing condition table 8 has a broad meaning and, instead of being a table, may have any specific parameter setting format as long as the parameters are actually set according to the packet types.

### Reference Signs List

B-1,B-2 buffer; 3 packet reception apparatus; 8 packet processing condition table; 15 packet extraction processing unit; 16,17 packet calculation processing unit

1. A packet reception apparatus receiving a plurality of types of packets classified in categories including at least one of a content of a request information from a transmission side, a type of packet communication format, and a video data compression method, comprising:
a plurality of buffers separately storing the plurality of types of received packets according to the types;
a packet extraction processing unit extracting the packets stored in the plurality of buffers according to a packet processing condition table; and
a packet calculation processing unit performing a calculation process of the packets extracted by the packet extraction processing unit.

2. The packet reception apparatus of claim 1, wherein the packet processing condition table includes priorities of the plurality of buffers and first threshold values for packet accumulation amounts in the plurality of buffers, and
the packet extraction processing unit extracts packets from the buffer having the highest priority among the buffers whose packet accumulation amounts are greater than the first threshold values.

3. The packet reception apparatus of claim 2, wherein the packet processing condition table includes second threshold values for packet accumulation amounts in the plurality of buffers,
the second threshold values are smaller than the first threshold values, and
when the packet accumulation amount of the buffer from which packets are being extracted becomes less than the second threshold value, the packet extraction processing unit switches the buffer from which packets are extracted.
